(19) United States
(12) Patent Application Publication
(10) Pub. No.: US 2012/0213994 A1
(43) Pub. Date: Aug. 23, 2012

(54) X-RAY ABSORBING COMPOSITIONS AND METHODS OF MAKING THE SAME

(75) Inventors: Huma Rahim Jafry, Houston, TX (US); Andrew Ross Barron, Houston, TX (US)

(73) Assignee: William Marsh Rice University, Houston, TX (US)

(21) Appl. No.: 13/351,550

(22) Filed: Jan. 17, 2012

Related U.S. Application Data
(60) Provisional application No. 61/432,647, filed on Jan. 14, 2011.

(51) Int. Cl. G21F 1/10; G21F 1/02; D01F 11/12; B82Y 40/00; B82Y 30/00

(52) U.S. Cl. 428/367; 252/478; 977/742; 977/734; 977/750; 977/752; 977/842

(57) ABSTRACT

Various embodiments of the present invention pertain to x-ray absorbing compositions that comprise a carbon material associated with an x-ray absorbing material. In some embodiments, the x-ray absorbing material is selected from the group consisting of lead-based compounds, bismuth-based compounds, and combinations thereof. In some embodiments, the carbon material is selected from the group consisting of carbon nanotubes, graphenes, carbon fibers, amorphous carbons, and combinations thereof. In further embodiments, the carbon materials of the present invention may also be treated with a surfactant, an acid, polymers or combinations thereof. In some embodiments, the carbon materials of the present invention may be further associated with a metal oxide. Additional embodiments of the present invention pertain to methods of making the aforementioned x-ray absorbing compositions. Such methods generally include associating a carbon material with an x-ray absorbing material.

### CROSS-REFERENCE TO RELATED APPLICATIONS

This application claims priority to U.S. Provisional Patent Application No. 61/432,647, filed on Jan. 14, 2011. The entirety of the above-identified provisional application is incorporated herein by reference.

### STATEMENT REGARDING FEDERALLY SPONSORED RESEARCH

This invention was not made with government support under any federal grants.

### BACKGROUND OF THE INVENTION

Current methods and apparatus for absorbing x-rays suffer from numerous limitations. Such limitations include the utilization of heavy and bulky materials with limited x-ray absorbing capacities. Therefore, a need exists for developing lightweight, compact and effective x-ray absorbing compositions.

### BRIEF SUMMARY OF THE INVENTION

In some embodiments, the present invention pertains to x-ray absorbing compositions that include a carbon material associated with an x-ray absorbing material. In some embodiments, the x-ray absorbing material is selected from the group consisting of lead-based compounds, bismuth-based compounds, and combinations thereof. In some embodiments, the carbon material is selected from the group consisting of carbon nanotubes, graphenes, carbon fibers, amorphous carbons, and combinations thereof.

In further embodiments, the carbon materials of the present invention may also be treated with surfactants, acids, polymers, and combinations thereof. In some embodiments, the carbon materials of the present invention may also be associated with a metal oxide, such as Si₂O.

Additional embodiments of the present invention pertain to methods of making the aforementioned x-ray absorbing compositions. Such methods generally include associating a carbon material with an x-ray absorbing material. In some embodiments, the associating step comprises coating the carbon material with the x-ray absorbing material. In some embodiments, the carbon material may also be treated with acids, bases, polymers, surfactants, and combinations thereof. In further embodiments, the methods of the present invention may also include a step of associating the carbon material with a metal oxide, such as Si₂O.

The methods and compositions of the present invention provide numerous applications and advantages. In some embodiments, the compositions of the present invention may be applied to various surfaces (e.g., papers, fabrics, and plastics) in the form of ink or paint. Thus, the methods and compositions of the present invention provide lightweight and inexpensive alternatives for effectively protecting various objects and surfaces from x-ray absorption.

### BRIEF DESCRIPTION OF THE FIGURES

FIG. 1 shows transmission electron microscopy (TEM) images of untreated vapor grown carbon fibers (VGCFs) (FIGS. 1A and 1B) and VGCFs treated with lead (Pb) salts in situ (FIGS. 1C and 1D).

FIG. 2 shows X-ray absorption by various VGCFs, including VGCFs treated with Pb salts in situ (FIG. 2A), VGCFs treated with lead nitrate salts (FIG. 2B), and untreated VGCFs (FIG. 2C).

FIG. 3 is a scanning electron microscopy (SEM) image showing spheres present on the outside of the VGCFs treated with Pb salts in situ.

FIG. 4 shows x-ray photoelectron spectroscopy (XPS) of untreated VGCFs (FIG. 4A) and VGCFs treated with Pb salts in situ (FIG. 4B).

FIG. 5 is a TEM image of multi-walled carbon nanotubes (MWNTs) coated with Pb salts. The TEM image shows the presence of Pb salts on the outside walls of the MWNTs.

FIG. 6 shows X-ray absorption by plain MWNTs (FIG. 6A) and MWNTs treated with Pb salts in situ (FIG. 6B).

FIG. 7 shows TEM images of VGCGs treated with Pb salts by a two step method. The images show the Pb salts inside the VGCFs.

FIG. 8 is a TEM image of MWNTs treated with Pb salts by a two step method. The image shows the etched sidewalls and miniscule presence of Pb salts.

FIG. 9 shows SEM images of MWNTs that were coated with lead sulfide (PbS) in the presence of sodium dodecyl sulfate (SDS). The images show a “petal like” fused structure between the MWNTs.

FIG. 10 shows an energy dispersive x-ray spectroscopy (EDX) of the MWNTS in FIG. 9. The EDX shows the presence of Pb and S on the MWNTs.

FIG. 11 shows SEM images of single-walled carbon nanotubes (SWNTs) coated with PbS compounds with the aid of cetyl trimethylammonium bromide (CTAB).

FIG. 12 shows X-ray absorption by the SWNTs in FIG. 11.

FIG. 13 shows SEM images of acid-treated VGCFs coated with a PbS compound.

FIG. 13A shows the VGCFs after a 2 hour reaction with a high concentration of the reactants. In this study, VGCF-H₂O was prepared by adding VGCF (30 mg) to DI H₂O (35 mL). An aliquot from this stock solution of acid treated VGCF-H₂O (3 mL) was mixed with DI H₂O (4.8 mL), ammonium hydroxide (1.15 M, 0.6 mL), thiourea (0.080 M, 0.6 mL), and lead acetate (0.080 M, 0.6 mL).

FIGS. 13B-13C show the VGCFs after a 2 hour reaction with low concentrations of the reactants. In this study, VGCF-H₂O was prepared by adding VGCF (30 mg) to DI H₂O (35 mL). An aliquot from this stock solution of acid treated VGCF-H₂O (6 mL) was mixed with DI H₂O (4.8 mL), ammonium hydroxide (1.15 M, 0.6 mL), thiourea (0.080 M, 0.6 mL), and lead acetate (0.080 M, 0.6 mL).

FIG. 14 shows SEM images of acid-treated VGCFs coated with PbS compounds.

FIG. 14A shows the VGCFs after a 4 hour reaction with high concentrations of reactants. In this study, VGCF-H₂O was prepared by adding VGCF (30 mg) to DI H₂O (35 mL). An aliquot from this stock solution of acid treated VGCF-H₂O (3 mL) was mixed with DI H₂O (4.8 mL), ammonium hydroxide (1.15 M, 0.6 mL), thiourea (0.080 M, 0.6 mL), and lead acetate (0.080M, 0.6 mL).

FIG. 14B shows the VGCFs after a 4 hour reaction with low concentrations of reactants. In this study, VGCF-H₂O was prepared by adding VGCF (30 mg) to DI H₂O (35 mL). An aliquot from this stock solution of acid treated VGCF-H₂O (6 mL) was mixed with DI H₂O (4.8 mL), ammonium hydroxide (1.15 M, 0.6 mL), thiourea (0.080 M, 0.6 mL), and lead acetate (0.080 M, 0.6 mL).

FIG. 15 shows XPS of acid-treated VGCFs coated with various Pb compounds. The VGCF samples were treated with low concentrations of the Pb compounds for 2 hours. In this study, VGCF-H₂O was prepared by adding VGCF (30 mg) to DI H₂O (35 mL). An aliquot from this stock solution of acid treated VGCF-H₂O (6 mL) was mixed with DI H₂O (4.8 mL), ammonium hydroxide (1.15 M, 0.6 mL), thiourea (0.080 M, 0.6 mL), and lead acetate (0.080 M, 0.6 mL).

FIG. 16 is an SEM image showing the coatings of VGCFs with bismuth sulfide (Bi₂S₃) in the presence of SDS.

FIG. 17 is an XPS of VGCFs coated with Bi₂S₃ using SDS, Bi₄f and S₂p peaks.

FIG. 18 shows SEM images of acid-treated VGCFs coated with Bi₂S₃.

FIG. 19 is an XPS of acid-treated VGCFs coated with Bi₂S₃ with overlapping Bi₄f and S₂p peaks.

FIG. 20 shows absorption data measured for coated VGCFs in comparison with commercial aprons.

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

X-rays were discovered in 1895. Since then, its advantages, disadvantages and sources have been studied in great depth. For instance, X-ray machines are extensively used in the medical and health care industries for therapeutic and diagnostic purposes. In the healthcare industry, 67% of the population in developed countries uses x-rays in some form of diagnostic and therapeutic care. In the underdeveloped and developing countries, 5-13% of the population uses X-rays for medical reasons. In fact, it is estimated by the United Nations that developing and underdeveloped countries will see a surge in the use of X-rays for diagnostic and therapeutic purposes.

Despite the benefits of X-rays for diagnostic and therapeutic purposes, prolonged and high doses of X-ray radiation are known for its damaging effects to humans and equipment. According to reports by the United Nations, prolonged exposure can lead to detrimental effects for humans, such as permanent burns, damage to the DNA and tissue cells, mutation of genes, and eventually cancer. Given the severity of the damage from X-rays, standards have been put in place by the government on protection practices for personnel and facilities using X-rays.

In order to ensure minimal X-ray radiation penetration, individuals who come in contact with X-rays are required to wear lead-lined protection wear, such as aprons, gloves, goggles, and thyroid protection. Three different categories of wearable protection include total (100%) lead-lined clothing, lead composite clothing, and non-lead clothing. While the total lead lined clothing has the highest protection against high and scattered low energy radiation, it is inflexible, extremely heavy (15.1 lbs/sq yard) and can cause severe back problems for individuals who wear them for many hours.

The lead composite clothing (9.1 lbs/sq yard) and non-lead clothing (similar to lead composite clothing) weigh less than the 100% lead-lined clothing. However, such clothing do not provide optimal protection against high and scattered radiation. Therefore, such clothing allow more radiation to penetrate an individual wearing the clothing. Thus, customers have a tough choice of choosing between clothing that provide higher radiation protection but are inflexible and heavy, and more lightweight clothing with less protection from radiation.

Accordingly, a need exists for developing lightweight materials that effectively absorb x-ray radiation. Various embodiments of the present invention address this need.

In some embodiments, the present invention pertains to an x-ray absorbing composition that includes a carbon material associated with an x-ray absorbing material (e.g., lead-based and/or bismuth-based compounds). Additional embodiments of the present invention pertain to methods of making such x-ray absorbing compositions. Further embodiments of the present invention pertain to applying such x-ray absorbing compositions to various objects and surfaces in order to provide protection against x-rays. More specific but non-limiting aspects of the present invention will now be described in more detail.

X-Ray Absorbing Compositions

In the present invention, x-ray absorbing compositions generally refer to compositions that are capable of absorbing x-rays. In some embodiments, x-rays include high energy and low energy x-ray photons, including low energy Compton scattering photons.

In some embodiments, the x-ray absorbing compositions of the present invention generally include a carbon material and an x-ray absorbing material that is associated with the carbon material.

Carbon Materials

The x-ray absorbing compositions of the present invention can include various carbon materials. Carbon materials generally refer to any carbon-based products. Non-limiting examples of suitable carbon materials include carbon nanotubes, graphenes, graphites, carbon fibers, amorphous carbons, and combinations thereof. In some embodiments, the carbon materials may be functionalized with various functional groups, such as carboxyl groups, hydroxyl groups, and combinations thereof.

In more specific embodiments, the carbon materials of the present invention include carbon fibers, such as vapor grown carbon fibers (VGCF). In further embodiments, the carbon fibers of the present invention may include graphite fibers.

In further embodiments, the carbon materials of the present invention may include carbon nanotubes. In some embodiments, the carbon nanotubes may be single-walled carbon nanotubes (SWNTs), multi-walled carbon nanotubes (MWNTs), double-walled carbon nanotubes (DWNTs), and combinations thereof. In some embodiments, the carbon nanotubes may be pristine carbon nanotubes. In some embodiments, the carbon nanotubes may be functionalized with one or more functional groups, such as carboxyl groups, hydroxyl groups, and combinations thereof.

In various embodiments, the carbon materials of the present invention may also be treated with various compounds. Such treatment may occur before, during or after the association of the carbon materials with an x-ray absorbing material. Such compounds may include, without limitation, surfactants, acids, bases, polymers and combinations thereof.

In some embodiments, the carbon materials may be treated with one or more surfactants. A non-limiting example of a suitable surfactant is sodium dodecyl sulfate (SDS). Additional suitable surfactants that may be used to treat carbon materials include, without limitation, dodecyl trimethylammonium bromide (DTAB), cetyl trimethylammonium bromide (CTAB), dodecylbenzenesulfonic acid (SDBS), and combinations thereof.

In some embodiments, the carbon materials of the present invention may be treated with an acid. Non-limiting examples of suitable acids include hydrochloric acid (HCl), sulfuric acid (H₂SO₄), acetic acid (CH₃COOH), hydrofluoric acid (HF), nitric acid (HNO₃), and combinations thereof.

In some embodiments, the carbon materials of the present invention may be treated with a superacid. Superacids generally refer to acids with an acidity greater than that of 100% pure sulfuric acid. Non-limiting examples of superacids include trifluoromethanesulfonic acid (CF₃SO₃H), fluorosulfonic acid (FSO₃H), perchloric acid (HClO₄), trifluoromethanesulfonic acid (CF₃SO₃H), and combinations thereof.

In some embodiments, the carbon materials of the present invention may be treated with a base. Non-limiting examples of bases include potassium hydroxide (KOH), barium hydroxide (Ba(OH)₂), caesium hydroxide (CsOH), sodium hydroxide (NaOH), strontium hydroxide (Sr(OH)₂), calcium hydroxide (Ca(OH)₂), magnesium hydroxide (Mg(OH)₂), lithium hydroxide (LiOH), rubidium hydroxide (RbOH), and combinations thereof.

In further embodiments, the carbon materials of the present invention may also be treated, coated or associated with a metal oxide. In some embodiments, the metal oxide is at least one of SiO₂, Na₂O, K₂O, Li₂O, Rb₂O, and combinations thereof. In some embodiments, the metal oxide is SiO₂.

X-Ray Absorbing Materials

X-ray absorbing materials generally refer to any materials capable of absorbing any amounts of x-ray photons. Various x-ray absorbing materials may be used in the x-ray absorbing compositions of the present invention. In some embodiments, the x-ray absorbing material is a lead-based compound, a bismuth-based compound, or combinations of lead-based and bismuth-based compounds.

In some embodiments, the x-ray absorbing material is a lead-based compound. In more specific embodiments, the lead-based compound is at least one of PbS, PbO, PbO₂, PbSO₃, PbSO₄, Pb(NO₃)₂, Pb₃O₄, Pb₃(OH)₂(CO₃)₂, Pb(OH)₄²⁻, Pb(OH)₆²⁻, PbCO₃, PbCl⁺, PbCl₂, PbCl₃⁻, PbCl₄⁻², or combinations thereof.

In more specific embodiments, the x-ray absorbing material is lead sulfide (PbS). By way of background, PbS is an important group IV-VI semiconductor. PbS has attracted considerable attention due to its small direct band gap (0.41 eV) and large excitation Bohr radius of 18 nm. Such attributes confer a strong quantum confinement of electrons and holes in PbS.

In some embodiments, the x-ray absorbing material is a bismuth-based compound. In more specific embodiments, the bismuth-based compound is at least one of Bi₂S₃, Bi₂O₃, Bi₂O₅, BiF₅, BiF₃, BiBr₃, BiI₃, BiH₃, Bi₂(SO₄)₃, Bi(NO₃)₃, BiO₂⁻, BiO₃⁻³, BiCl₃, or combinations thereof.

In more specific embodiments, the x-ray absorbing material is bismuth sulfide (Bi₂S₃). By way of background, Bi₂S₃ is a chalcogenide group V-VI semiconductor. Materials containing Bi₂S₃ have also been of great interest because of its large photoconductivity, absorption coefficients, direct band gap (1.2-1.7 eV), and high thermoelectric power. Potential applications of Bi₂S₃ lie in the fields of photodetectors, liquid-junction solar cells, thermoelectric coolers, hydrogen sensors, and X-ray computed tomography (CT) imaging agents.

Association of X-Ray Absorbing Materials with Carbon Materials

X-ray absorbing materials may be associated with carbon materials in various manners. In some embodiments, the x-ray absorbing material is coated on the carbon material. In some embodiments, the coating may form a layer of x-ray absorbing materials on carbon materials. Such layers may have a range of thicknesses. In some embodiments, the thickness of the x-ray absorbing material on the carbon material may range from about 1 nm to about 1 μm. In more specific embodiments, the thickness of the x-ray absorbing material on the carbon material may range from about 1 nm to about 500 nm.

In other embodiments, the x-ray absorbing material may be embedded or dispersed within the carbon material. In further embodiments, the x-ray absorbing material may be intertwined with the carbon material. Additional forms of association can also be envisioned.

Methods of Making X-Ray Absorbing Compositions

Additional embodiments of the present invention pertain to methods of making the aforementioned x-ray absorbing compositions. Such methods generally include associating a carbon material with an x-ray absorbing material.

In some embodiments, the associating step comprises coating the carbon material with the x-ray absorbing material. The coating may be done by various methods. A non-limiting example of a coating method is chemical bath deposition (CBD). Additional suitable coating methods include plating, chemical solution deposition (CSD), chemical vapor deposition (CVD), plasma enhanced vapor deposition (PECVD), physical vapor deposition (PVD), sputtering, pulsed laser deposition, cathodic arc deposition (arc-PVD), electrohydrodynamic deposition, reactive sputtering, molecular beam epitaxy (MBE), topotaxy, and the like.

In some embodiments, the associating step comprises embedding carbon materials with x-ray absorbing materials. Various methods may be used to embed carbon materials with x-ray absorbing materials. Two exemplary methods include capillary fillings using molten media and wet chemistry techniques.

Capillary fillings can entail mixing x-ray absorbing materials (e.g., metals or metal salts) with carbon materials (e.g., CNTs). The mixture may then be transferred into a vacuum sealed tube for heating until the x-ray absorbing material (e.g., metal) is molten. Once molten, the x-ray absorbing material (e.g., metal) can be drawn into the carbon material (e.g., CNTs) via capillary action.

When CNTs are utilized as carbon materials, another capillary filling methodology entails opening the caps of the CNTs and using capillary action to add molten x-ray absorbing materials (e.g., metals) into the CNTs. This is achieved by heating the tubes in the presence of oxygen or carbon dioxide and the x-ray absorbing material (e.g., metal). The heating will oxidize the caps of the tubes and thereby open them for the filling. This technique produces a higher percentage of tubes with open caps.

Wet chemistry techniques can also be used to embed carbon materials with x-ray absorbing materials. For instance, in some embodiments, CNTs are treated with an acid and a metal salt in order to open and fill the tubes with metals.

In some embodiments, the association of carbon materials with x-ray absorbing materials can be done in situ using a one step process. See, e.g., Nature, 1994, 372, 159. In a one step process, the carbon materials (e.g., CNTs) are simultaneously treated with a solvent (e.g., acid) and an x-ray absorbing material (e.g., metal salts dissolved in aqueous solutions).

In other embodiments, the association of carbon materials with x-ray absorbing materials can be performed using a two step process. See, e.g., J. Cryst. Growth, 1997, 173, 81. In a two step process, the carbon materials (e.g., CNTs) are first etched and washed. This is followed by treating the carbon materials with x-ray absorbing materials (e.g., aqueous solutions of metal salts).

In various embodiments, the carbon material may also be treated with acids, bases, surfactants, polymers, and combinations thereof. In further embodiments, the methods of the present invention may also include a step of associating the carbon material with a metal oxide, such as Si₂O. Such additional steps may occur before, during, or after associating carbon materials with x-ray absorbing materials.

Applications and Advantages

The methods and compositions of the present invention provide numerous applications and advantages. For instance, the x-ray absorbing compositions of the present invention may be applied to various surfaces to protect them from x-ray absorption. In various embodiments, such surfaces can include, without limitation, papers, fabrics, and plastics. In more specific embodiments, the compositions of the present invention may be applied to solar cells, computed tomography (CT) contrast agents, hydrogen sensors and infrared (IR) detectors.

In further embodiments, the compositions of the present invention may be applied to various surfaces in the form of paints or inks. In more specific embodiments, the compositions of the present invention may be used as inks or paints for printing materials on various surfaces. The printed materials may then be incorporated into various products to make lightweight X-ray absorbing materials and devices. In other embodiments, functional groups on the carbon materials or x-ray absorbing materials may be used to bond the compositions of the present invention to various surfaces. For instance, in some embodiments, the coated tubes can also be chemically functionalized and bonded to the weaves of threads of various fabrics.

Advantageously, the x-ray absorbing compositions and materials of the present invention provide lightweight and more cost effective alternatives to absorbing x-ray photons. Furthermore, unlike other x-ray absorbing products currently in the market, the materials and compositions of the present invention can absorb x-rays and low energy Compton scattering photons in a more effective manner.

### Additional Embodiments

Reference will now be made to more specific embodiments of the present disclosure and experimental results that provide support for such embodiments. However, Applicants note that the disclosure below is for exemplary purposes only and is not intended to limit the scope of the claimed invention in any way.

The Examples below pertain to methods of coating carbon nanotubes (CNTs) with lead sulfide (PbS) and bismuth sulfide (Bi₂S₃). In conducting these studies, Applicants aimed to see if materials could be developed that could both absorb x-rays and weigh less than the traditional 100% lead lined gowns. These x-ray absorbing materials could then be incorporated within different radiation protection wearable products, thereby providing protection and comfort.

In these studies, Applicants focused on making nanoparticles and coatings of lead and bismuth compounds, as both lead and bismuth absorb x-rays. Applicants also explored the different techniques used to fill vapor grown carbon fibers (VGCFs) and multi-walled carbon nanotubes (MWNTs) with Pb salts. Applicants also tested the x-ray absorbing capacities of the formed compositions.

By way of background, various methodologies have been employed for making different sizes and types of nanoparticles and film coatings of metal sulfide, and in particular PbS and Bi₂S₃. Some of these techniques include using surfactants that act as structure directing and capping agents. Other techniques include the utilization of polymer compounds for templates, and substrates that contain hydroxyl groups for the deposition of metal sulfide nanoparticles. Other techniques utilize no surfactants.

While others have made various sizes and forms of PbS and Bi₂S₃ nanoparticles and thin films, Applicants are unaware of any studies pertaining to coating CNTs with PbS and Bi₂S₃. A general mechanism that is used to make copper sulfide (CuS) and PbS nanoparticles is as follows:

Pb(NH₃)₄²⁺→Pb²⁺+4NH₃ (1)

NH₃+H₂O→NH₄⁺+OH⁻ (2)

(NH₂)₂CS+2OH⁻→S²⁻+2H₂O+H₂CN₂ (3)

Pb²⁺+S²⁻→PbS (4)

In the reaction, the role of ammonium hydroxide is two fold. It forms a basic form of lead acetate. This in turn controls the rate of reaction by limiting the availability of free Pb²⁺ ions. The ammonium hydroxide also creates an alkaline environment for the hydrolysis of thiourea. Previously, a similar reaction mechanism was utilized by Applicants to coat SWNTs with cadmium sulfide. Here, Applicants utilize a similar preparation to coat CNTs with PbS and Bi₂S₃.

### Example 1

### Filling of MWNTs and VGCFs with Lead

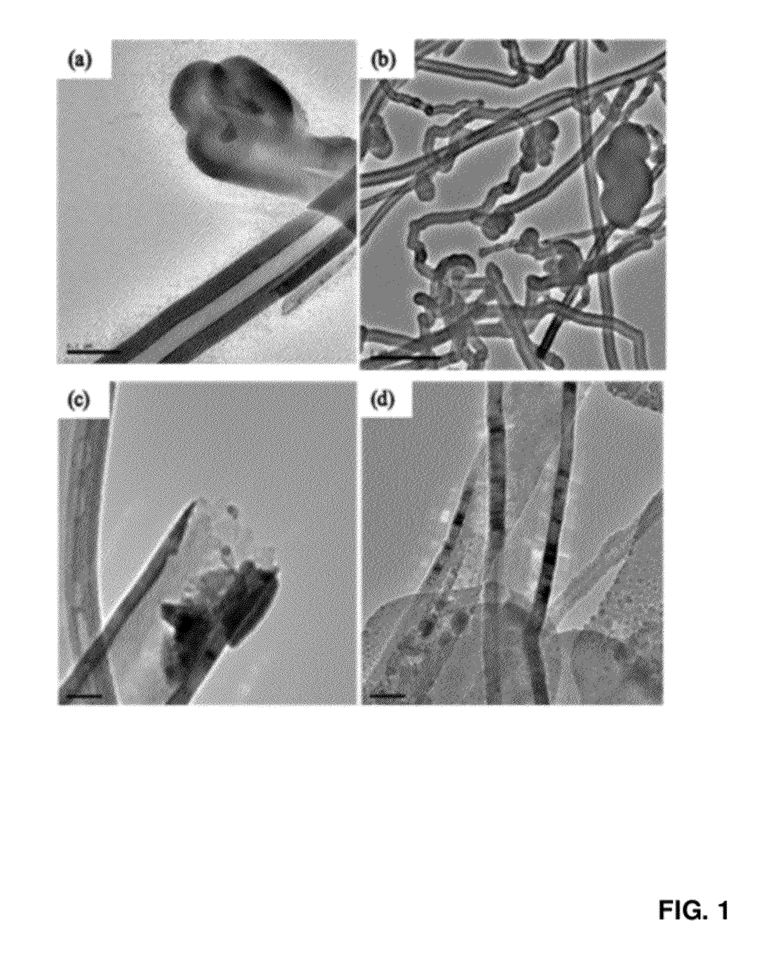

The in situ method and the two step method have been used to associate PbS with VGCFs and MWNTs. FIG. 1 shows the transmission electron microscopy (TEM) images of untreated VGCFs (FIGS. 1A-1B), and VGCFs treated with Pbs via the in situ method (FIGS. 1C-1D). For instance, FIG. 1C shows either etched off carboneous material or lead salts on the openings of the VGCFs. FIG. 1D shows some particles/spheres around the VGCFs.

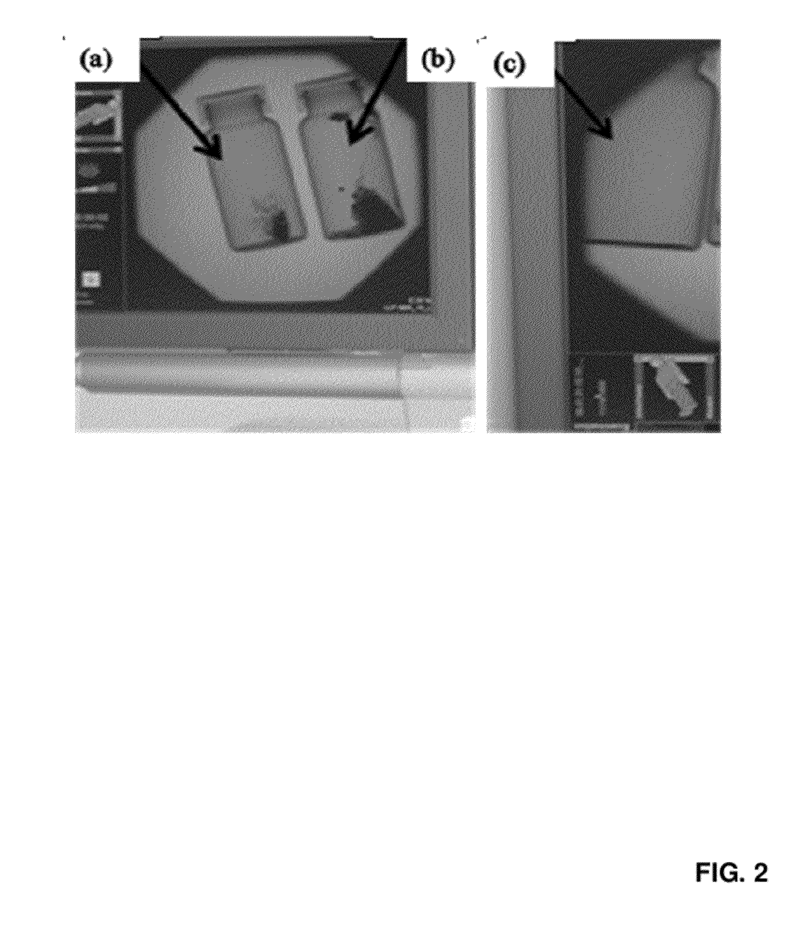

An X-ray test shown in FIG. 2 reveals that there is significant absorption of the X-rays by the treated VGCFs (FIGS. 2A-2B). However, the untreated plain VGCFs have no absorption (FIG. 2C).

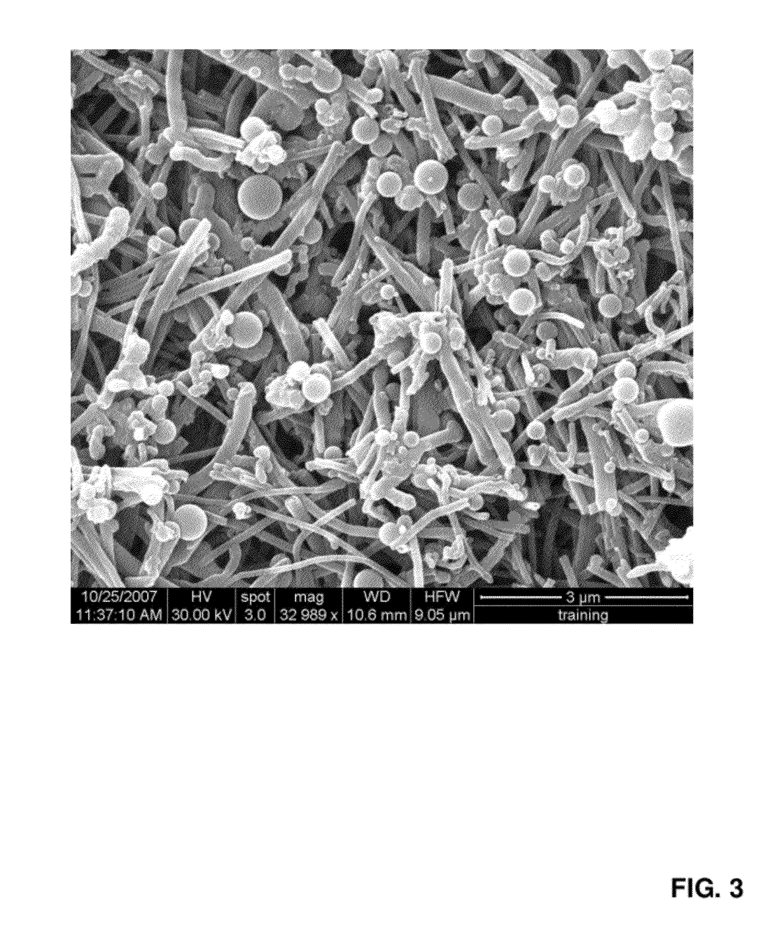

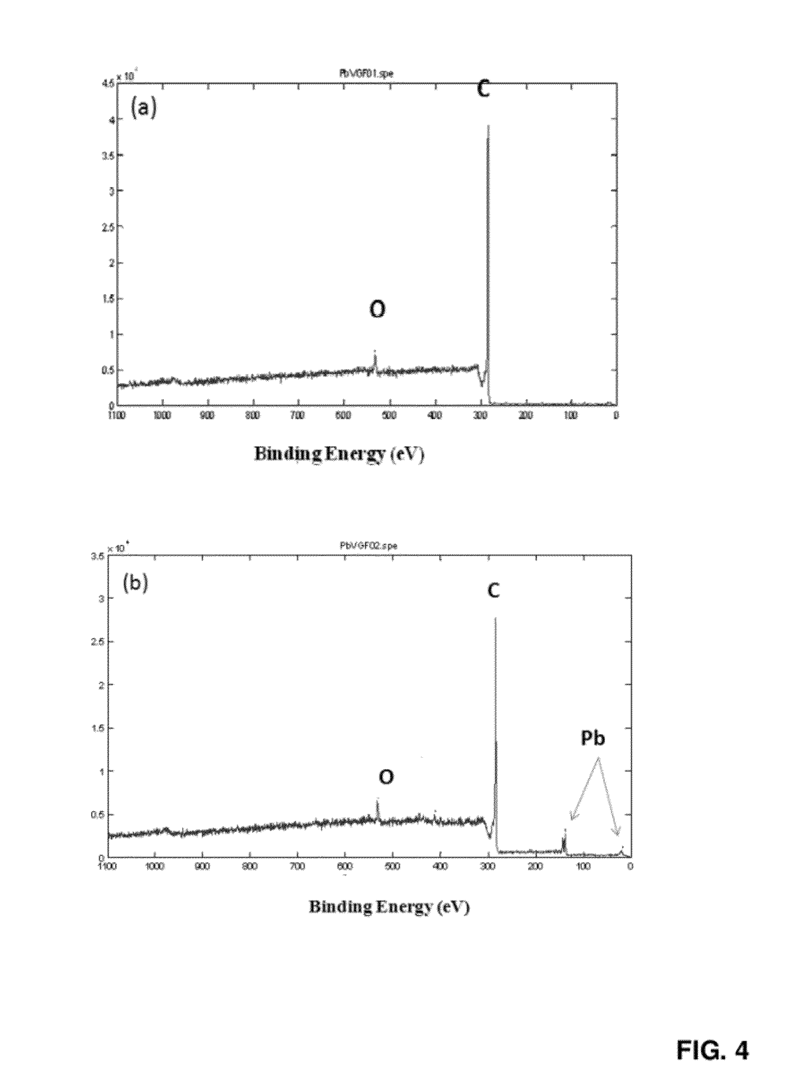

As shown in FIG. 3, scanning electron microscopy (SEM) was performed on these samples. The image reveals that there are spheres present on the outside of the VGCFs, which may have accumulated during the reflux/calcination process of lead salts with VGCFs. X-ray photoelectron spectroscopy (XPS) results (FIG. 4) confirm the presence of lead on the surface of the VGCFs.

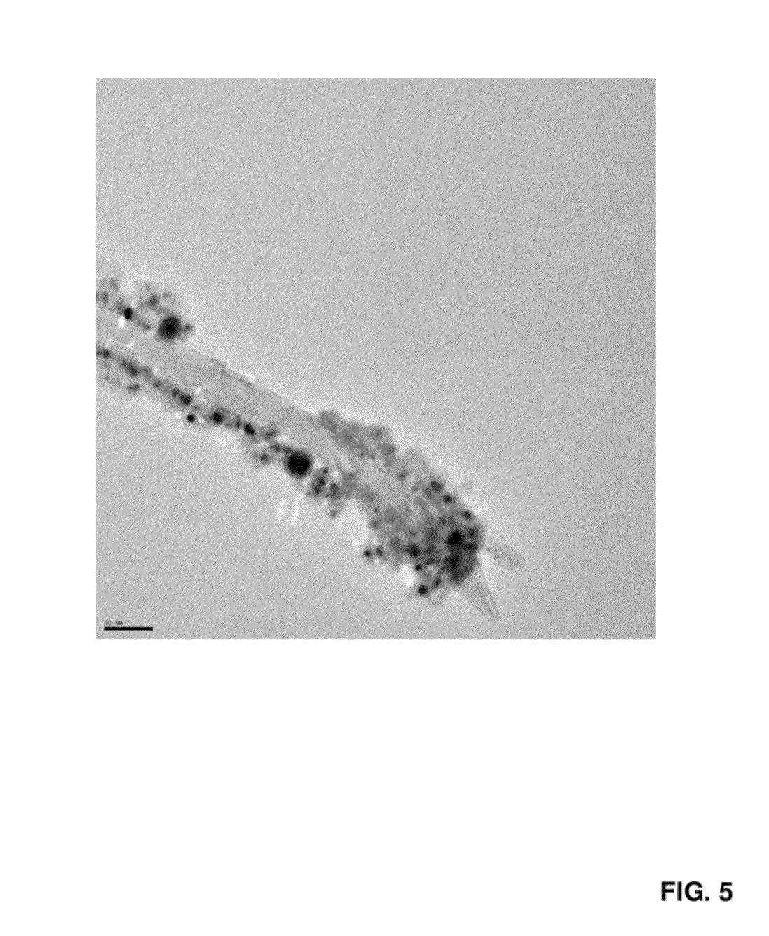

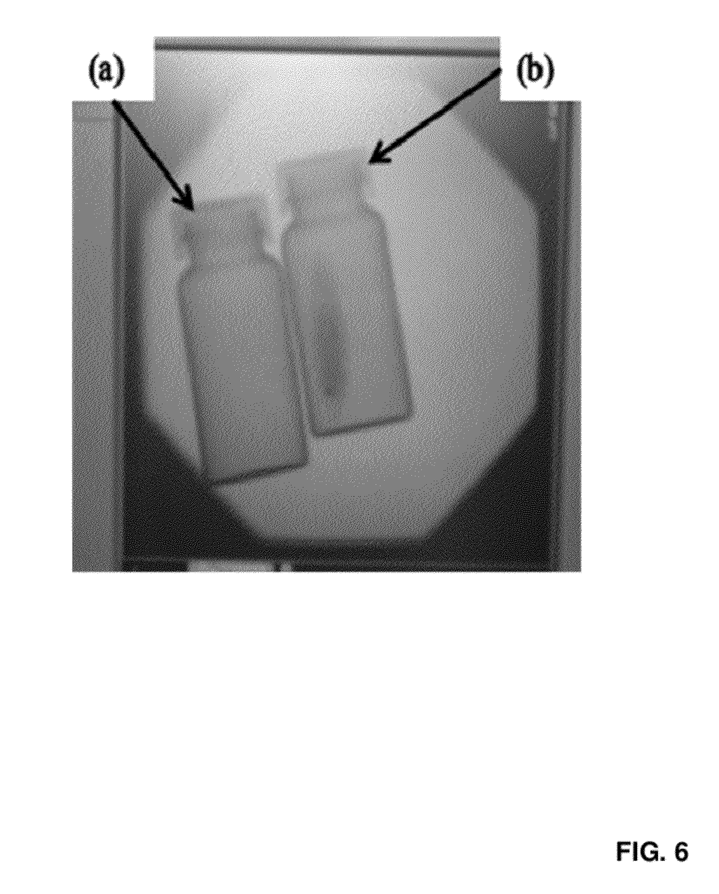

In a similar fashion, MWNTs can also be associated with lead by the in situ method. See FIG. 5. As is the case with VGCFs, small spheres of lead are visible on the outside of the MWNTs, with no visible amounts of lead present on the inside. The X-ray absorption pictures shown in FIG. 6 reveal x-ray absorption by the treated MWNTs.

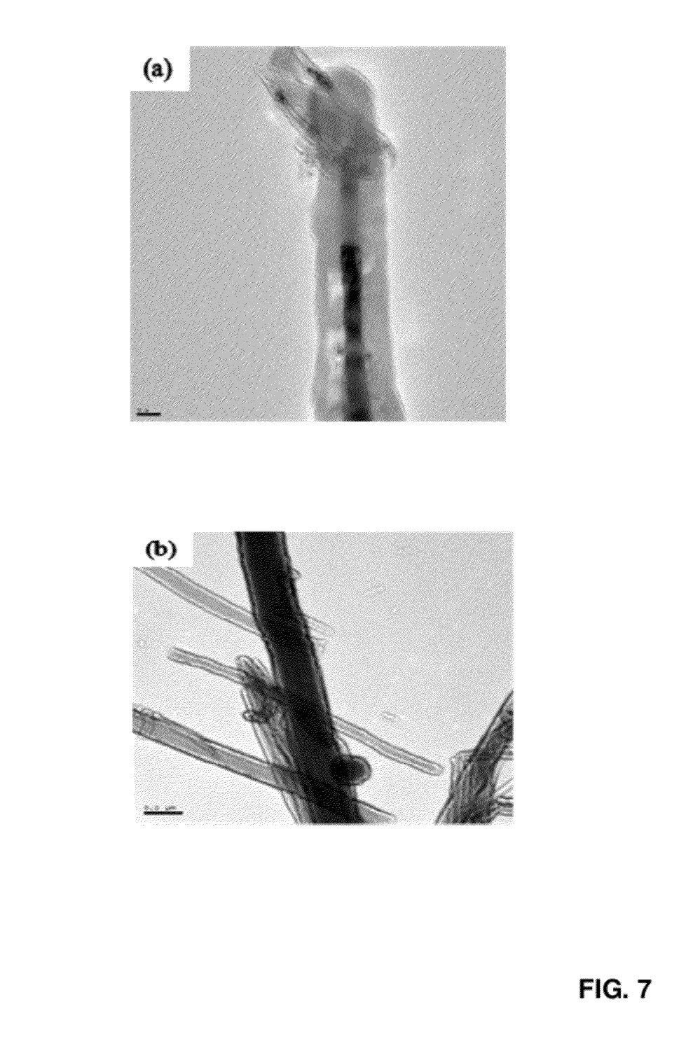

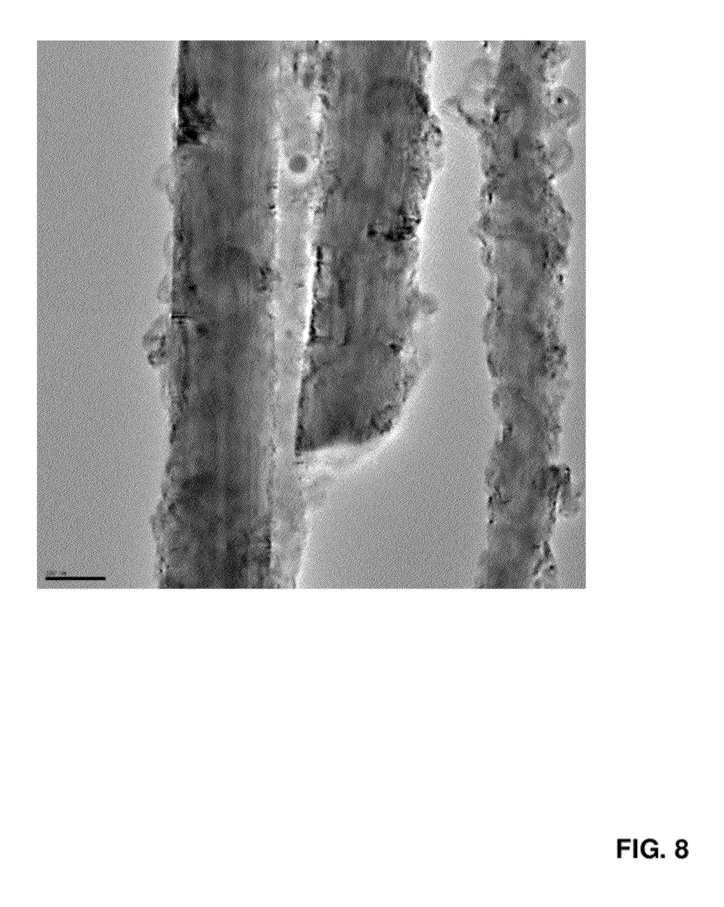

The two step method was also used to associate PbS with VGCFs and MWNTs. As shown in the TEM in FIG. 7, the presence of lead can be seen inside the treated VGCFs, even though there was no X-ray absorption of tubes. As shown in the TEM in FIG. 8, the treated MWNTs displayed etched sidewalls and the presence of some specs of lead. While the filling of the MWNTs is quite unlike the fillings obtained with the VGCFs, neither the treated VGCFs nor the MWNTs absorbed any X-rays. Given the above results, Applicants envision that x-rays can be absorbed if there is presence of lead on the surface of the tubes.

### Example 2

### Coating CNTs Using Surfactants

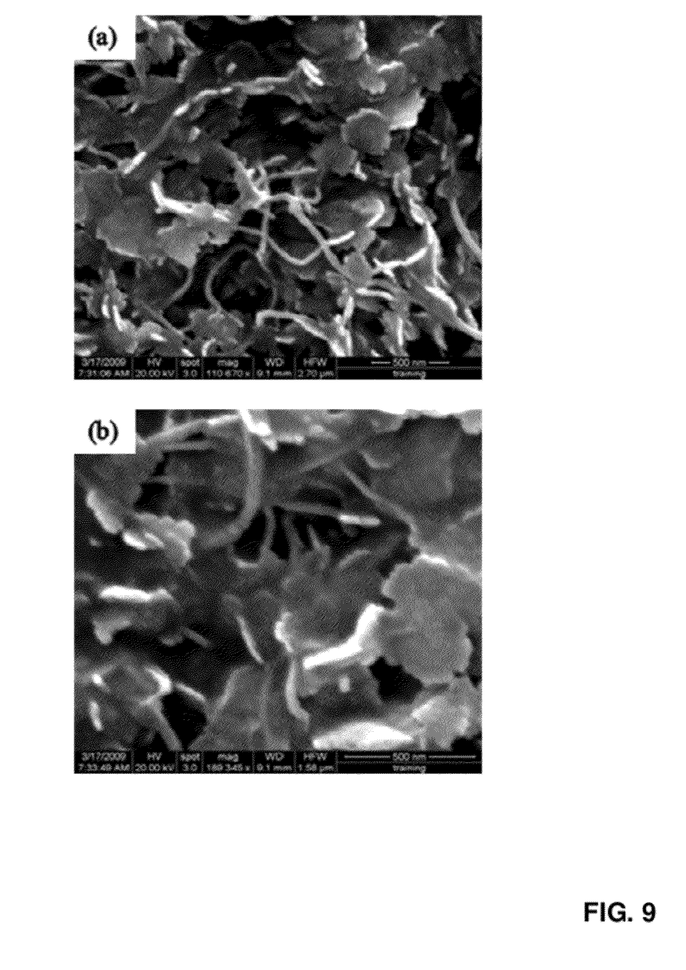

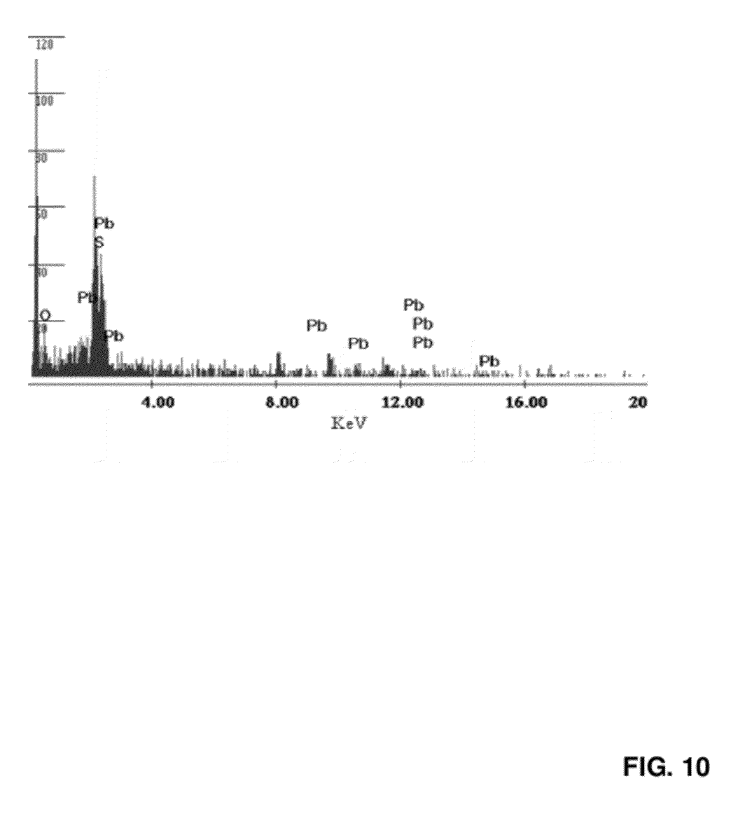

In this Example, sodium dodecyl sulfate (SDS) was used to coat MWNTs with PbS compounds. As shown in the SEM images in FIG. 9, the coatings display uneven and “petal like” growth of PbS compounds in between the MWNTs. Furthermore, the energy dispersive x-ray spectroscopy (EDX) elemental analysis shown in FIG. 10 confirms the presence of lead and sulfur.

Previously, the presence of surfactants in liquid phase diffusion (LPD) growth solutions have shown colloidal growth along the nanotube surface as deposition takes place around the micelles. A similar reaction to make PbS nanocrystallites has also been reported by Dong and co-workers. J. Colloid Interface Sci., 2006, 301, 503. According to their report, the concentration of the surfactant played a significant role in determining the types of nanostructures of PbS formed.

Without being bound by theory, it is envisioned that surfactants act as capping and structure directing agents by adsorbing to certain facets of the crystal structure and controlling the direction of crystal growth. In fact, when Dong et al. increased their surfactant concentrations, they obtained “downy-velvet flower” like structures, which are quite similar to those observed in FIG. 9. Given the significant “fused flower petals” within the tubes, it seems that in this case, the deposition is more of a composite nature than coating of individual MWNTs. Thus, Applicants envision that it is possible that changing the concentration of the surfactants would yield different growths on the CNTs.

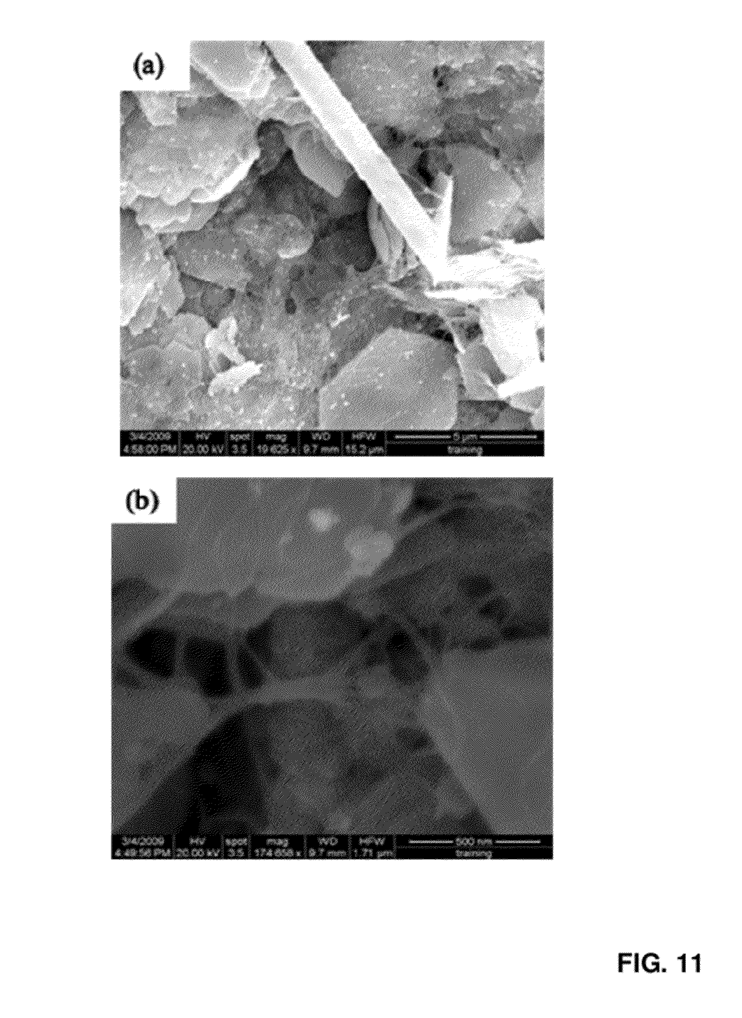

In another study, cetyl trimethylammonium bromide (CTAB) was also used to coat SWNTs with PbS. As can be seen in the SEM images in FIG. 11, the SWNTs seem to be bundled. In addition, there are “boulder like” structures of Pb compounds present within the SWNTs-PbS matrix. Previously, Applicants have shown that, in order to coat CNTs in an acidic medium, it is best to use dodecyl trimethylammonium bromide (DTAB) or CTAB as surfactants. Likewise, Applicants have shown that SDS and dodecylbenzenesulfonic acid (SDBS) work best in basic media. See, e.g., Nano Lett., 2003, 3, 775 and Main Group Chem., 2005, 4, 279.

Using SDS or SDBS to coat SWNTs in acidic media have led to the coating of SWNT bundles, rather than individual tubes. However, it has been previously reported in literature that PbS crystallites form under similar reaction conditions in the presence of CTAB. See, e.g., Colloid Interface Sci., 2006, 301, 503.

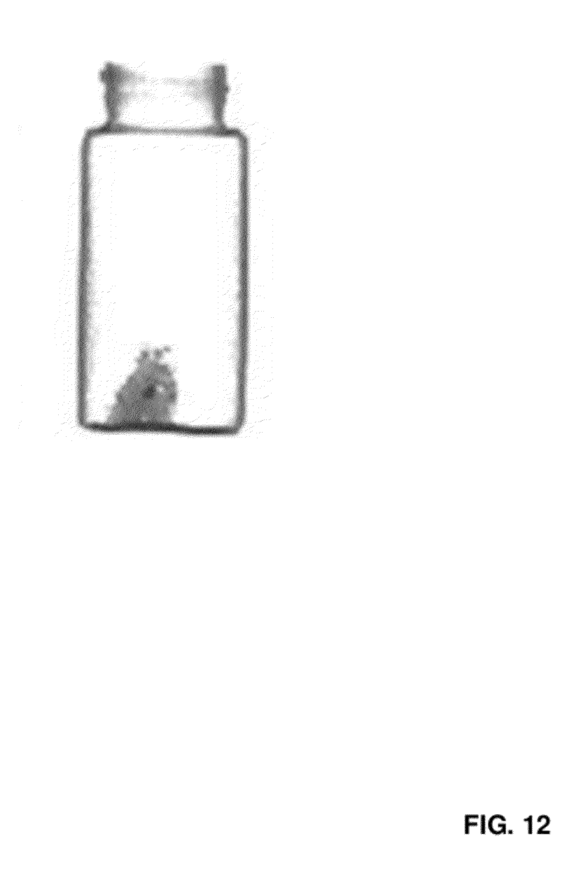

Without being bound by theory, Applicants envision that these boulders could be produced as a consequence of either a higher concentration of reactants and/or the presence of CTAB in a basic medium. Furthermore, applicants envision that such boulders could contribute to the x-ray absorption of the coated carbon materials. For instance, an X-ray absorption study shows good absorption of the SWNTs coated with PbS in the presence of surfactants. See, e.g., FIG. 12.

### Example 3

### Coating Acid-Treated VGCFs with PbS

In this example, Applicants aimed to determine if acid-treated VGCFs could also be used to obtain an even coating of PbS on the VGCFs. To the best of Applicants' knowledge, this is the first time carbon materials are coated with PbS.

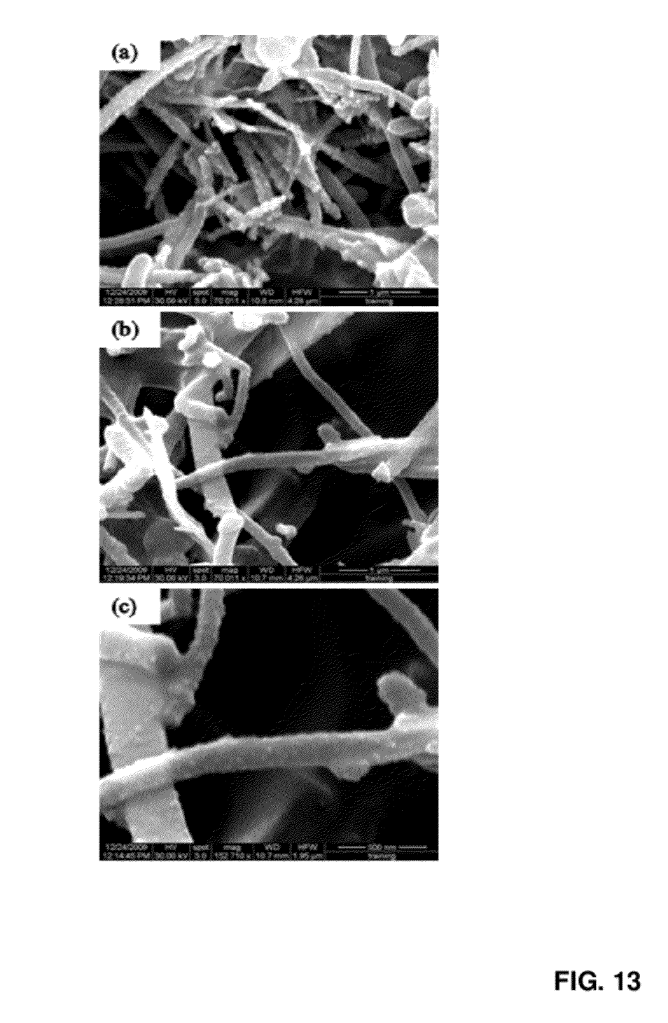

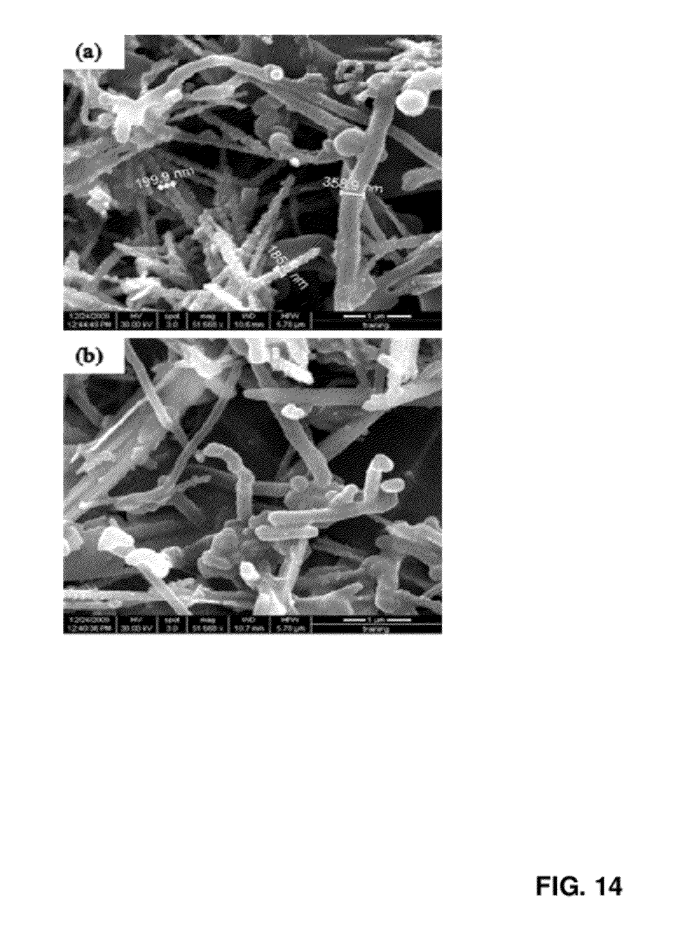

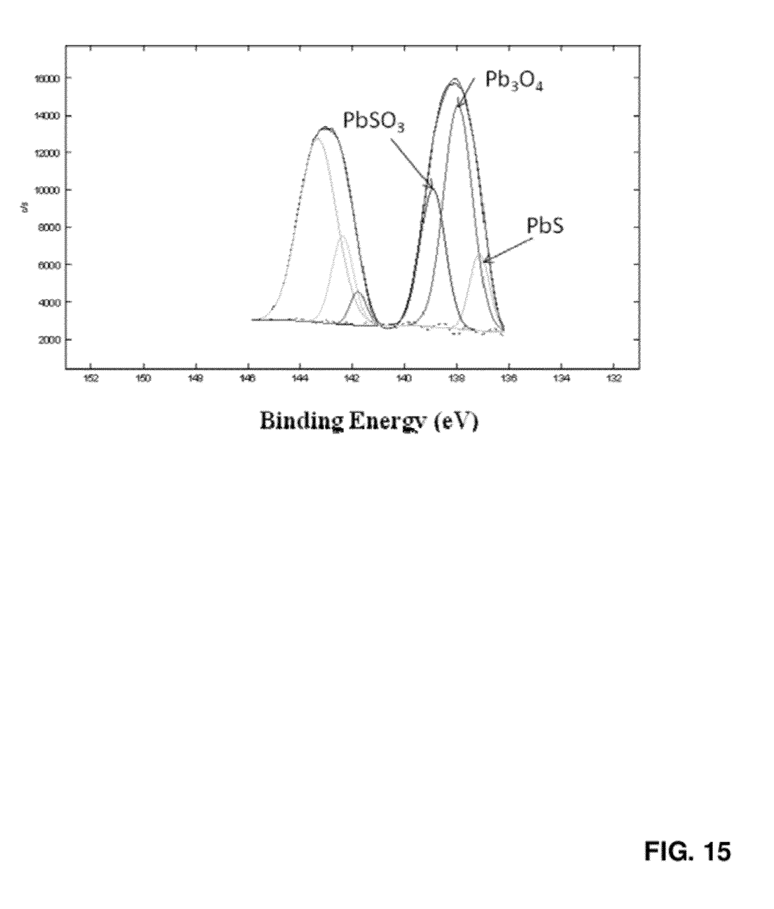

As shown in the SEM images in FIGS. 13-14, the outer PbS coatings of the VGCFs are colloidal but even. Likewise, XPS results shown in FIG. 15 reveal the presence of PbS and other Pb compounds.

The amount of colloids present on the surface of the VGCF is dependent on the concentrations of reactants present. The higher the concentration of reactants, the more colloidal the growth. However, looking at the SEM image of the coated VGCFs from the lower reactant concentration, there is a presence of very minute and small colloids. See FIG. 13C. Without being bound by theory, Applicants envision that such colloids may be due to the presence of hydroxyl and carboxyl groups on the acid-treated VGCFs.

Previously in the literature, it has been described that for thin film coatings of CdS on substrates, the presence of OH groups on substrates or solution made a significant difference in the type of coatings achieved. J. Phys. Chem., 1994, 98, 5338. It has been reported that substrates with the presence of Cd(OH)₂ groups allowed for the nucleation and growth of CdS. The formation of CdS occurred by the adsorption of thiourea on Cd(OH)₂, followed by the decomposition of Cd(OH)₂-thiourea complex. However, substrates which had no presence of OH groups showed films of poor surface coverage that were less adherent to the substrate. The coatings on acid-treated VGCFs are different from the coatings obtained by surfactants. It is possible that there is good adhesion of PbS and other Pb compounds (FIG. 15) due to the initial presence of OH groups.

### Example 4

### Coating of VGCFs with Bi₂S₃ Using SDS

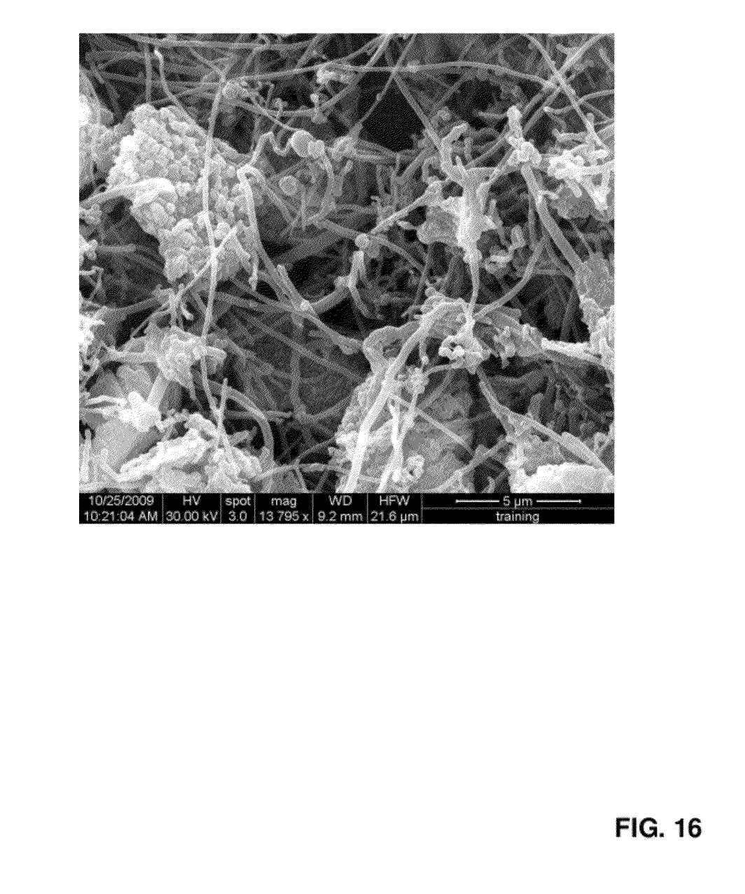

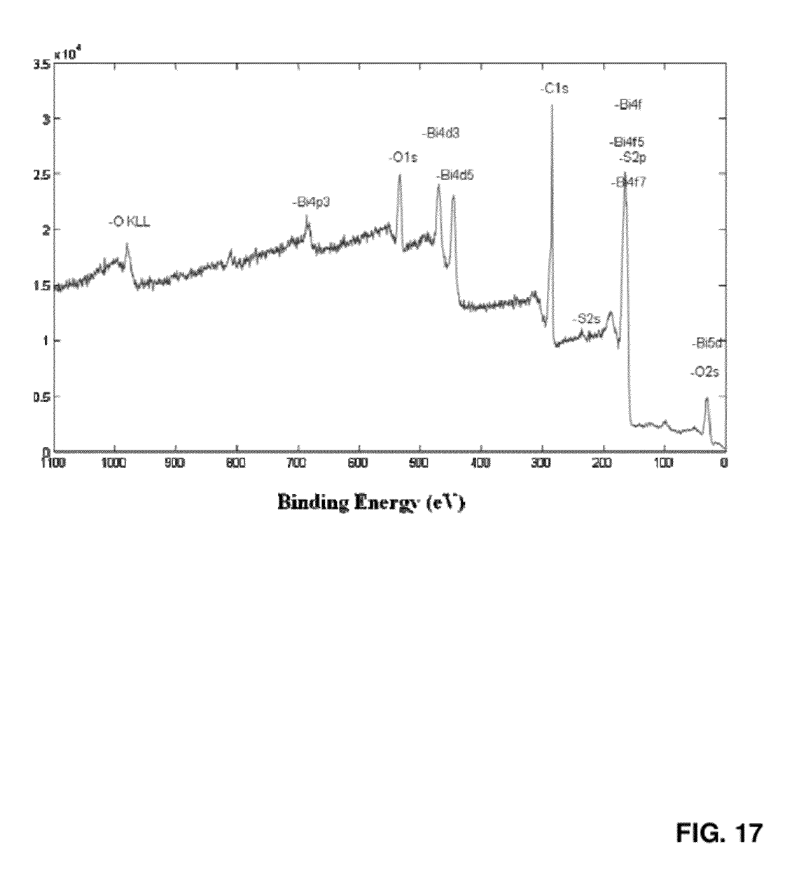

In this Example, SDS was used as a surfactant to disperse VGCFs in order to coat them with Bi₂S₃ compounds. As can be seen in the SEM image in FIG. 16, while there is growth on the surface on the VGCFs, there is also a small presence of colloids. The surfactant micelles present in solution and around the VGCFs act as templates around which deposition takes place to form colloids. As shown in FIG. 17, XPS results confirm the presence of Bi³⁺ and S²⁻. However, there is an overlap of Bi₄f and S₂p peaks.

### Example 5

### Coating of Acid-Treated VGCF with Bi₂S₃

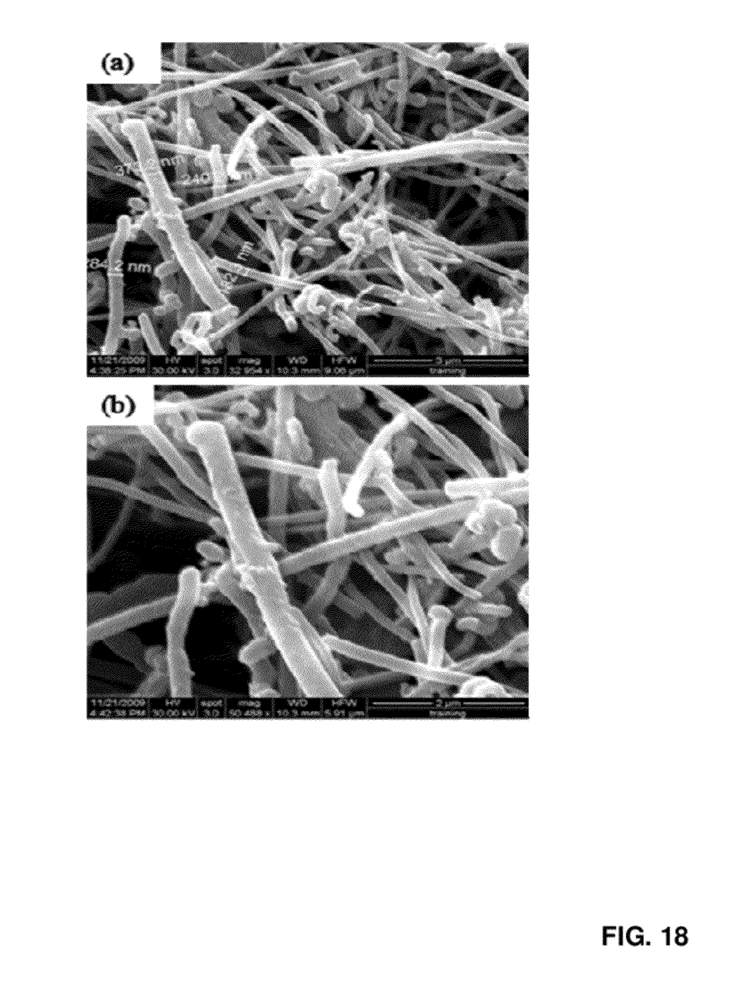

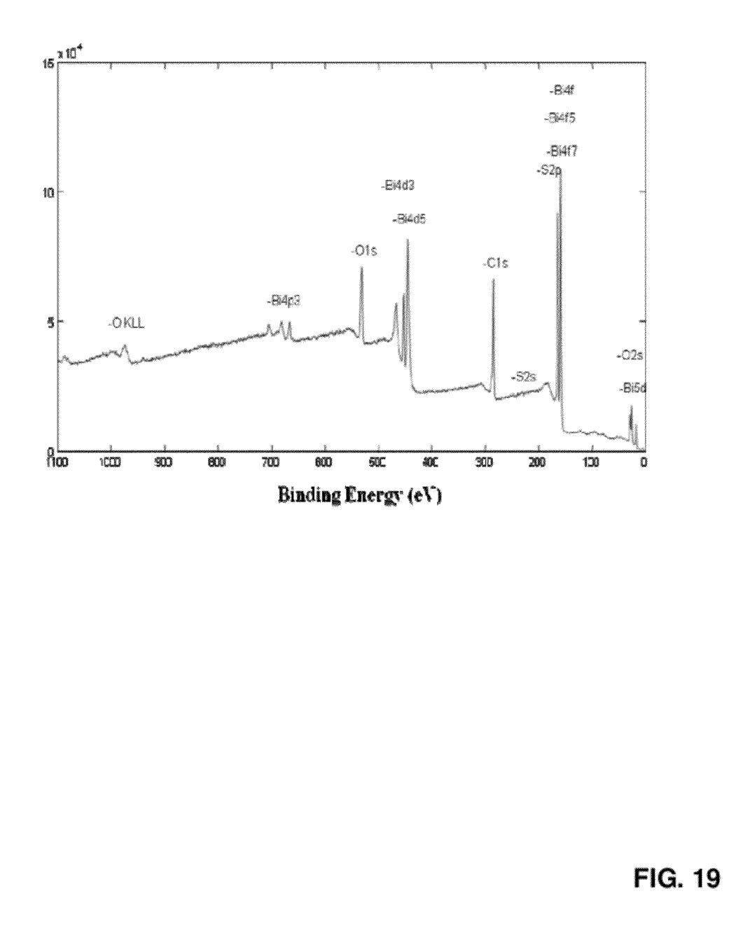

In addition to coating VGCFs with Bi₂S₃ using surfactants, Applicants also coated acid-treated VGCFs with Bi₂S₃ in order to investigate any differences in the coatings. FIG. 18 shows the coatings of acid-treated VGCFs with Bi₂S₃ compounds. FIG. 19 shows an XPS analysis of the VGCFs. The VGCFs coated in the presence of SDS seem to have an uneven growth, while the acid-treated VGCFs have a more even growth of Bi₂S₃.

### Example 6

### X-Ray Absorption of Coated CNTs

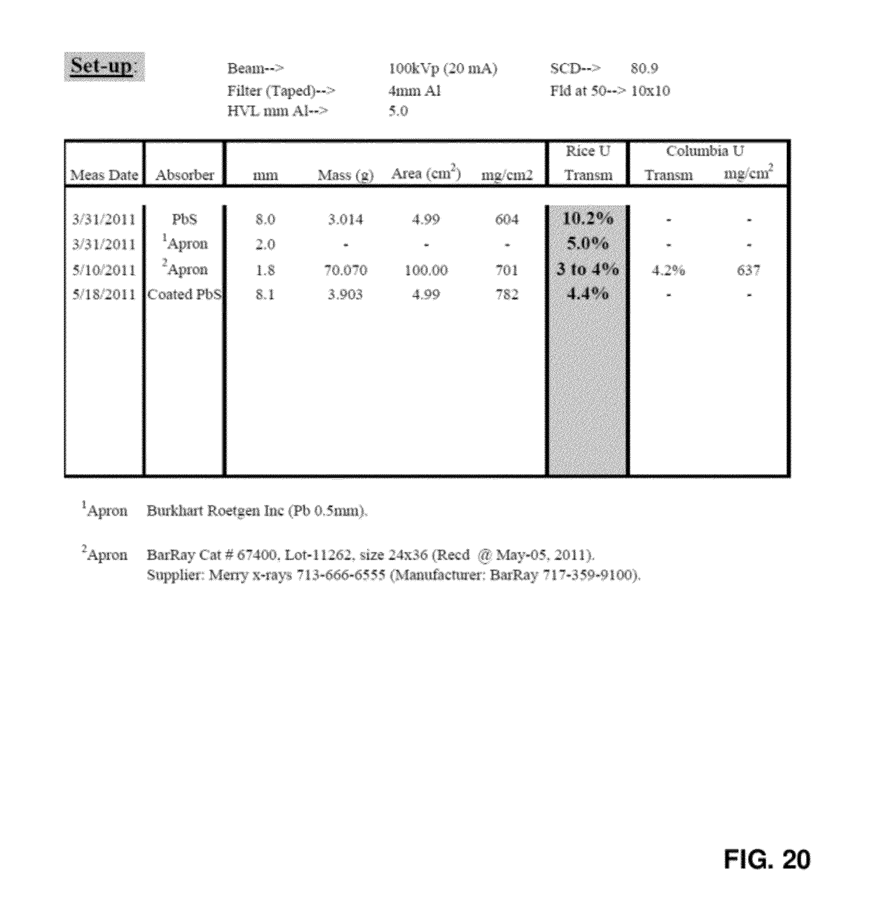

As summarized in FIG. 20, the radiation attenuation of PbS-coated VGCFs were compare with standard Pb aprons used in hospitals. Column 1 shows dates of testing. Column 2 lists the tested materials. PbS designates materials which have a single layer of PbS coatings on VGCFs. Apron 1 and Apron 2 are standard commercially available aprons. Coated PbS designates materials which have a double layer of PbS coating on VGCFs. The columns of importance are the mg/cm² column (showing total weight per unit area of materials being tested), and the Columbia U column (showing the results obtained on X-ray radiation transmission on commercially available Apron 2, as tested by Columbia University).

Apron 2 (commercially available apron) shows a relatively similar weight per unit area to that of the Coated PbS (the invention). Under the same testing conditions, radiation transmission attained by the Barron lab on Apron 2 is between 3-4%. The Columbia research study shows a comparable radiation transmission of 4.2% on Apron 2.

Using the same testing conditions as those set forth for Apron 2, the PbS materials show a radiation transmission of 4.4%. To summarize, these results show that the x-ray absorption of PbS materials (the invention) are comparable to commercially available lead-lined aprons when comparing the radiation transmission and the total weight of the radiation absorbing materials. Furthermore, the testing parameters and results are consistent with the third party study (Columbia University) done on commercially available lead-lined aprons.

In sum, Applicants have investigated the fillings of various carbon materials with lead-based and bismuth-based x-ray absorbing materials using two different methods. In the first in situ method, Applicants found that there was no filling of CNTs with metal or metal salts, and the X-ray absorption was based on metal salts present on the outside of the CNTs. Using a two step process, Applicants were successful in filling VGCFs with metal/metal salts, but not MWNTs. Nonetheless, there was no X-ray absorption from tubes filled using a two step process.

Applicants also investigated different methodologies of coating CNTs with PbS and Bi₂S₃ compounds using the aid of surfactants and acid-treated tubes. It turns out that the acid-treated tubes give a more even growth of the metal sulfide nanoparticles compared to the surfacted tubes. Also, the “type of colloidal” coating present on the acid-treated VGCFs is dependent on the concentration of reactants. The ability for the acid-treated and coated VGCFs to absorb x-rays is currently under investigation. Furthermore, Applicants observed that the x-ray absorbing materials of the present invention are able to match or exceed the radiation attenuation percentage of standard commercially available Pb aprons of equal weight.

### Example 7

### Experimental Protocols

MWNTs (Cheap Tubes, >95 wt. %, 8-15 nm outer diameter), lead nitrate (Pb(NO₃)₂, Sigma-Aldrich), lead acetate (Pb(CH₃CO₂)₄, Sigma-Aldrich), thiourea (Sigma-Aldrich), ammonium hydroxide (29 wt. %, Fisher), sodium dodecyl sulfate (SDS, Sigma-Aldrich), cetyl trimethylammonium bromide (DTAB, Sigma-Aldrich), cetyl trimethylammonium bromide (CTAB) (Sigma-Aldrich), and chloroform (Sigma-Aldrich) were used as received without any further purification.

### Example 7.1

### Pb Fillings of VGCFs and MWNTs (In Situ/One Step)

VGCFs or MWNTs (100 mg) were added to a round bottom flask containing concentrated nitric acid (69-71 wt. %, 11 mL) and lead nitrate (500 mg). The mixture was set to reflux while stirring in an oil bath at 140° C. for 4.5 hours. After the allotted reaction time, the nitric acid was evaporated, followed by the drying of the fibers in a furnace at 100° C. overnight. The fibers were calcined in a furnace under the following conditions: VGCFs or MWNTs were heated under argon at 10° C. min⁻¹ to 100° C. for 1 hour, followed by ramping the temperature to 580° C. at 10° C. min⁻¹ for 5 hours. The samples were then cooled down to 470° C. at 10° C. min⁻¹ and the gas was switched to hydrogen. The samples were kept under hydrogen for 2-14 hours.

### Example 7.2

Pb Fillings of VGCFs and MWNTs (Two-Step)

VGCF or MWNTs (100 mg) were added to a round bottom flask containing concentrated nitric acid (69-71 wt. %, 22 mL). The mixture was set to reflux while stirring for allotted amounts of time (4.5 hours, 12 hours). After reflux, the fibers were filtered and washed off with copious amounts of acetone and DI H₂O, followed by chloroform. The tubes were then dried off overnight at 100° C. in a furnace.

Acid-treated VGCFs (25 mg) or MWNTs (15 mg) were added to a solution of lead nitrate in DI H₂O (53.8 M, 100-125 mg in 5-7 mL DI H₂O) and refluxed while stirring for an allotted time (4 hours, 12 hours). After reflux, the mixture was allowed to cool to room temperature, followed by centrifuging for 5 minutes at 4400 rpm. The supernatant was discarded, and the VGCFs were dried in a furnace at 100° C. overnight. A similar calcination procedure was followed for the in situ process described above.

### Example 7.3

Coating MWNTs with PbS Using SDS Surfactant

MWNTs (30 mg) were probe sonicated in a SDS solution (1 wt. %, 150 mL) for 10 minutes, followed by centrifugation for 10 minutes at 4400 rpm. The supernatant was saved, and the process of centrifugation was repeated 3 times. The supernatant was separated for further experiments. MWNT-SDS solution (3 mL) was mixed with ammonium hydroxide (1.15 M, 0.6 mL), thiourea (0.080 M, 0.6 mL), and lead acetate (0.080 mL, 0.6 mL). The mixture was set to stir for 4 hours at room temperature. After the allotted reaction time, the mixture was added to EtOH (35 ml) and centrifuged for 10 minutes at 4400 rpm. The decant was discarded and centrifugation/discarding process was repeated 5 more times using EtOH.

### Example 7.4

### Coating SWNTs with PbS Using CTAB Surfactant

SWNTs (10 mg) were probe sonicated in a CTAB solution (1 wt. %, 80 mL) for 10 minutes, followed by centrifugation for 10 minutes at 4400 rpm. The supernatant was saved, and the process of centrifugation was repeated 3 times. The supernatant was separated for further experiments. SWNT-CTAB solution (80 mL) was added to a plastic bottle and was set on stirring. To this, CS₂ (0.06 mL) was added and stirred for 5 minutes, followed by the addition of ammonium hydroxide (0.89 mL) and lead acetate (0.1M, 9.6 mL). The bottle was lightly capped and stirred in an oil bath at 40 C for 24 hours. Afterwards, 20 mL aliquots of the mixture were added to EtOH:MeOH (4:1, 25 mL) and centrifuged for 10 minutes at 4400 rpm. The decant was trashed, and the coated SWNTs were washed with DI H₂O (30 mL) 2-3 times using centrifugation/discarding of the decant. The SWNTs were dried at 100° C. in a furnace overnight, followed by calcination under hydrogen for 2 hours at 455° C.

### Example 7.5

Coating Acid-Treated VGCF with PbS

VGCFs (150 mg) were added to concentrated nitric acid (69-71 wt. %, 50 mL) and stirred in a pyrex beaker in open air at 40° C. for 5 days until the nitric acid was evaporated. The acid-treated VGCFs were filtered and washed with copious amounts of acetone and DI H₂O, followed by chloroform treatment. A stock solution of acid-treated VGCF-H₂O was prepared by adding VGCF (30 mg) to DI H₂O (35 mL). An aliquot from this stock solution of acid-treated VGCF-H₂O (3 mL) was mixed with DI H₂O (4.8 mL), ammonium hydroxide (1.15 M, 0.6 mL), thiourea (0.080 M, 0.6 mL), and lead acetate (0.080 mL, 0.6 mL). The mixture was set to stir for 2 hours at room temperature. After the allotted reaction time, the mixture was added to EtOH (35 mL) and centrifuged for 10 minutes at 4400 rpm. The decant was then discarded. The centrifugation/discarding process was repeated 5 more times using EtOH.

### Example 7.6

Coating VGCFs with Bi₂S₃ Using SDS Surfactant

VGCFs (30 mg) were probe sonicated in a SDS solution (1 wt. %, 150 mL) for 10 minutes, followed by centrifugation for 10 minutes at 4400 rpm. The supernatant was saved, and the process of centrifugation was repeated 3 times. The supernatant was separated for further experiments. VGCF-SDS solution (50 mL) was mixed with bismuth nitrate (0.00004 mol, 19.4 mg) and thiourea (0.00008 mol, 6 mg) and stirred for 2 hours at 45° C. After the allotted reaction time, 20 mL aliquots of the mixture were added to EtOH (25 mL) and centrifuged for 10 minutes at 4400 rpm. The decant was discarded, and the centrifugation/dispersion process was repeated 5 times.

### Example 7.7

Coating Acid-Treated VGCFs with Bi₂S₃

VGCFs (150 mg) were added to concentrated nitric acid (69-71 wt. %, 50 mL) and stirred in a pyrex beaker in open air at 40° C. for 5 days until the nitric acid was evaporated. The acid-treated VGCFs were filtered and washed with copious amounts of acetone and DI H₂O, followed by chloroform treatment. Acid-treated VGCFs (8 mg) were then sonicated with DI H₂O (50 mL). To this, bismuth nitrate (0.00004 mol, 19.4 mg) and thiourea (0.00008 mol, 6 mg) were added and sonicated for a minute, followed by stirring at 45 C for 4 hours. After the allotted reaction time, 20 mL aliquots of the mixture were added to EtOH (25 mL) and centrifuged for 10 minutes at 4400 rpm. The decant was discarded, and the centrifugation/dispersion process was repeated 5 times.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. An x-ray absorbing composition comprising:
a carbon material; and
an x-ray absorbing material associated with the carbon material, wherein the x-ray absorbing material is selected from the group consisting of lead-based compounds, bismuth-based compounds, and combinations thereof.

2. The x-ray absorbing composition of claim 1, wherein the carbon material is selected from the group consisting of carbon nanotubes, graphenes, carbon fibers, amorphous carbons, and combinations thereof.

3. The x-ray absorbing composition of claim 1, wherein the carbon material comprises a vapor grown carbon fiber (VGCF).

4. The x-ray absorbing composition of claim 1, wherein the carbon material comprises carbon nanotubes selected from the group consisting of single-walled carbon nanotubes, multi-walled carbon nanotubes, double-walled carbon nanotubes, and combinations thereof.

5. The x-ray absorbing composition of claim 1, wherein the carbon material is treated with a surfactant.

6. The x-ray absorbing composition of claim 5, wherein the surfactant is sodium dodecyl sulfate (SDS).

7. The x-ray absorbing composition of claim 1, wherein the carbon material is treated with an acid.

8. The x-ray absorbing composition of claim 1, wherein the carbon material is further associated with a metal oxide.

9. The x-ray absorbing composition of claim 8, wherein the metal oxide is selected from the group consisting of SiO₂, Na₂O, K₂O, Li₂O, Rb₂O, and combinations thereof.

10. The x-ray absorbing composition of claim 1, wherein the x-ray absorbing material is a lead-based compound selected from the group consisting of PbS, PbO, PbO₂, PbSO₃, PbSO₄, Pb(NO₃)₂, Ph₃O₄, Pb₃(OH)₂(CO₃)₂, Ph(OH)₄²⁻, Pb(OH)₆²⁻, PbCO₃, PbCl⁺, PbCl₂, PbCl₃⁻, PbCl₄⁻², and combinations thereof.

11. The x-ray absorbing composition of claim 1, wherein the x-ray absorbing material is a bismuth-based compound selected from the group consisting of Bi₂S₃, Bi₂O₃, Bi₂O₅, BiF₅, BiF₃, BiBr₃, BiI₃, BiH₃, Bi₂(SO₄)₃, Bi(NO₃)₃, BiO₂⁻, BiO₃⁻³, BiCl₃, and combinations thereof.

12. The x-ray absorbing composition of claim 1, wherein the x-ray absorbing material is coated on the carbon material.

13. A method of making an x-ray absorbing composition, said method comprising:
associating a carbon material with an x-ray absorbing material,
wherein the x-ray absorbing material is selected from the group consisting of lead-based compounds, bismuth-based compounds, and combinations thereof.

14. The method of claim 13, further comprising a step of treating the carbon material with an acid.

15. The method of claim 13, further comprising a step of treating the carbon material with a surfactant.

16. The method of claim 13, wherein the associating step comprises coating the carbon material with the x-ray absorbing material.

17. The method of claim 13, wherein the associating step occurs in situ.

18. The method of claim 13, wherein the carbon material is selected from the group consisting of carbon nanotubes, graphenes, carbon fibers, amorphous carbons, and combinations thereof.

19. The method of claim 13, wherein the x-ray absorbing material is a lead-based compound selected from the group consisting of PbS, PbO, PbO₂, PbSO₃, PbSO₄, Pb(NO₃)₂, Pb₃O₄, Pb₃(OH)₂(CO₃)₂, Pb(OH)₄²⁻, Pb(OH)₆²⁻, PbCO₃, PbCl⁺, PbCl₂, PbCl₃⁻, PbCl₄⁻², and combinations thereof.

20. The method of claim 13, wherein the x-ray absorbing material is a bismuth-based compound selected from the group consisting of Bi₂S₃, Bi₂O₃, Bi₂O₅, BiF₅, BiF₃, BiBr₃, BiI₃, BiH₃, Bi₂(SO₄)₃, Bi(NO₃)₃, BiO₂⁻, BiO₃⁻³, BiCl₃, and combinations thereof.

21. The method of claim 13, further comprising a step of associating the carbon material with a metal oxide.

22. The method of claim 21, wherein the metal oxide is selected from the group consisting of SiO₂, Na₂O, K₂O, Li₂O, Rb₂O, and combinations thereof.
